(19) United States
(12) Patent Application Publication
(10) Pub. No.: US 2026/0270891 A1
(43) Pub. Date: Sep. 10, 2026

(54) SECONDARY CELL POWER HEADROOM REPORT REPORTING

(71) Applicant: QUALCOMM Incorporated, San Diego, CA (US)

(72) Inventors: Sitaramanjaneyulu KANAMARLAPUDI, San Diego, CA (US); Naveen Kumar R. PANAKANAPALLI, San Diego, CA (US)

(21) Appl. No.: 19/536,818

(22) Filed: Feb. 11, 2026

Related U.S. Application Data
(60) Provisional application No. 63/769,617, filed on Mar. 10, 2025.

(51) Int. Cl. H04W 52/36; H04W 52/24; H04W 52/34

(52) U.S. Cl. CPC H04W 52/365; H04W 52/242; H04W 52/34

(57) ABSTRACT

Thus, aspects of the present disclosure describe carrier aggregation dynamically enabling a secondary Cell (SCell) based on UE-reported buffer status report (BSR) and power head (PHR), optimizing power headroom reporting (PHR) reporting to enhance throughput, latency, power spectral efficiency. The UE may calculate an initial PHR for a SCell based on a combination of a PHR reported for a primary cell (PCell) as a baseline and an estimated SCell path loss relative to the PCell. The UE may also adjust the PHR for the SCell based on subsequent actual uplink transmissions on the SCell. The UE may dynamically adjust PHR for a specific cell based on total available UE power and network scheduling patterns. The UE may report the PHR on the SCell based on network scheduling.

This application claims priority to U.S. Provisional Application No. 63/769,617 titled “SECONDARY CELL PHR REPORTING,” filed Mar. 10, 2025, which is assigned to the assignee hereof, and incorporated herein by reference in its entirety.

### TECHNICAL FIELD

Aspects of the present disclosure relate generally to wireless communication systems, and more particularly, to a wireless communication system between a network device and a user equipment (UE).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect includes a method of wireless communication at a user equipment (UE), comprising calculating an initial power headroom report (PHR) for a secondary cell (SCell) based on a combination of a PHR reported for a primary cell (PCell) as a baseline and an estimated SCell path loss relative to the PCell. The method further includes adjusting the PHR for the SCell based on subsequent actual uplink transmissions on the SCell. Additionally, the method further includes adjusting the PHR for a specific cell based on total available UE power and network scheduling patterns. Additionally, the method further includes reporting the PHR on the SCell based on network scheduling.

Another example aspect includes an apparatus for wireless communication at a user equipment (UE), comprising one or more memories and one or more processors coupled with one or more memories and configured to perform, individually or in any combination, the following actions. The one or more processors are configured to calculate an initial PHR for a SCell based on a combination of a PHR reported for a PCell as a baseline and an estimated SCell path loss relative to the PCell. The one or more processors are further configured to adjust the PHR for the SCell based on subsequent actual uplink transmissions on the SCell. Additionally, the one or more processors are further configured to adjust the PHR for a specific cell based on total available UE power and network scheduling patterns. Additionally, the one or more processors are further configured to report the PHR on the SCell based on network scheduling.

Another example aspect includes an apparatus for wireless communication at a UE, comprising means for calculating an initial PHR for a SCell based on a combination of a PHR reported for a PCell as a baseline and an estimated SCell path loss relative to the PCell. The apparatus further includes means for adjusting the PHR for the SCell based on subsequent actual uplink transmissions on the SCell. Additionally, the apparatus further includes means for adjusting the PHR for a specific cell based on total available UE power and network scheduling patterns. Additionally, the apparatus further includes means for reporting the PHR on the SCell based on network scheduling.

Another example aspect includes a computer-readable medium comprising stored instructions for wireless communication at a UE, wherein the instructions are executable by one or more processors to calculate an initial PHR for a SCell based on a combination of a PHR reported for a PCell as a baseline and an estimated SCell path loss relative to the PCell. The instructions are further executable to adjust the PHR for the SCell based on subsequent actual uplink transmissions on the SCell. Additionally, the instructions are further executable to adjust the PHR for a specific cell based on total available UE power and network scheduling patterns. Additionally, the instructions are further executable to report the PHR on the SCell based on network scheduling.

An example aspect includes a method of wireless communication at a network entity, comprising receiving a PHR report from an apparatus for a PCell and at least one SCell. The method further includes analyzing PHR values from the PHR report to determine an available transmission power at a user equipment. Additionally, the method further includes adjusting uplink grant allocations to optimize power spectral efficiency.

Another example aspect includes an apparatus for wireless communication at a network entity, comprising one or more memories and one or more processors coupled with one or more memories and configured to perform, individually or in any combination, the following actions. The one or more processors are configured to receive a PHR report from an apparatus for a PCell and at least one SCell. The one or more processors are further configured to analyze PHR values from the PHR report to determine an available transmission power at a user equipment. Additionally, the one or more processors are further configured to adjust uplink grant allocations to optimize power spectral efficiency.

Another example aspect includes an apparatus for wireless communication at a network entity, comprising means for receiving a PHR report from an apparatus for a PCell and at least one SCell. The apparatus further includes means for analyzing PHR values from the PHR report to determine an available transmission power at a user equipment. Additionally, the apparatus further includes means for adjusting uplink grant allocations to optimize power spectral efficiency.

Another example aspect includes a computer-readable medium comprising stored instructions for wireless communication at a network entity, wherein the instructions are executable by one or more processors to receive a PHR report from an apparatus for a PCell and at least one SCell. The instructions are further executable to analyze PHR values from the PHR report to determine an available transmission power at a user equipment. Additionally, the instructions are further executable to adjust uplink grant allocations to optimize power spectral efficiency.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, wherein dashed lines may indicate optional elements, and in which:

FIG. 1A is a diagram illustrating an example of a wireless communications system and an access network;

FIG. 1B is a conceptual diagram of an example Open Radio Access Network architecture;

FIG. 2A is a diagram illustrating an example of a first frame, in accordance with various aspects of the present disclosure;

FIG. 2B is a diagram illustrating an example of downlink channels within a subframe, in accordance with various aspects of the present disclosure;

FIG. 2C is a diagram illustrating an example of a second frame, in accordance with various aspects of the present disclosure;

FIG. 2D is a diagram illustrating an example of uplink channels within a subframe, in accordance with various aspects of the present disclosure;

FIG. 3 is a diagram illustrating an example of a protocol architecture of a network device and user equipment (UE) in an access network;

FIG. 4 illustrates an example resource allocation in a wireless communication system;

FIG. 5 is a flowchart of an example of a method of wireless communication at a user equipment (UE);

FIG. 6 is a flowchart of additional aspects of the method of FIG. 5;

FIG. 7 is a flowchart of additional aspects of the method of FIG. 5; and

FIG. 8 is a flowchart of an example of a method of wireless communication at a network entity;

FIG. 9 is a flowchart of additional aspects of the method of FIG. 8;

FIG. 10 is a flowchart of additional aspects of the method of FIG. 8;

FIG. 11 is a flowchart of additional aspects of the method of FIG. 8;

FIG. 12 is a flowchart of additional aspects of the method of FIG. 8;

FIG. 13 is a flowchart of additional aspects of the method of FIG. 8;

FIG. 14 is a diagram illustrating an example of a hardware implementation for an apparatus employing a processing system; and

FIG. 15 is a diagram illustrating an example of a hardware implementation for an apparatus employing a processing system for a base station.

Like reference numbers and designations in the various drawings indicate like elements.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, the concepts and related aspects described in the present disclosure may be implemented in the absence of some or all of such specific details. In some instances, well-known structures, components, and the like are shown in block diagram form in order to avoid obscuring such concepts.

The Power Headroom Report (PHR) is a key component of the MAC Control Element procedure, enabling the User Equipment (UE) to inform the network about its available power headroom based on received signal power (RSRP) and path loss. This helps determine the amount of data the UE can transmit effectively, considering power spectral efficiency and available power. The UE transmission power is constrained by the lower value between its power class and the maximum transmission power configured by the network. Network-controlled power limits are influenced by factors such as topology, layered planning, and interference management, which impact overall system performance in CDMA/FDMA deployments.

In a cellular network, the UE is primarily connected to a primary cell (PCell), which manages essential signaling and data transmissions. However, to optimize network performance and distribute traffic efficiently, a secondary cell (SCell) can be dynamically activated or deactivated based on network conditions. This approach helps offload data traffic from the PCell, improving overall throughput and power spectral efficiency. The decision to activate an SCell depends on factors such as network topology, dynamic load balancing between PCell and SCell, and the power spectral efficiency of the system.

The network determines when to activate or deactivate an SCell using multiple key metrics. These include the amount of outstanding data at the UE, reported through the Buffer Status Report (BSR), the available power headroom at the UE, conveyed through the PHR, and the transmission success rate, measured using Block Error Rate (BLER) and Automatic Repeat reQuest (ARQ) mechanisms at the Radio Link Control (RLC) layer. Among these, BSR provides a direct and straightforward indication of how much data the UE has ready for transmission, allowing the network to efficiently allocate resources and decide which link (PCell or SCell) should be used for transmission grants.

While BSR follows a clear logic, PHR reporting introduces complexities due to its cell-specific nature. PHR indicates the total available power at the UE, but how this power is distributed across different cells is left to UE implementation, with specifications providing only broad guidelines. This variability means that network schedulers may interpret UE-reported PHR differently, leading to potential inefficiencies. If the UE reports a lower PHR for a specific cell, it may negatively impact scheduling, as the network may assume limited transmission capability. Conversely, reporting maximum PHR on each cell can result in increased scheduling when grants are provided for one link but lead to power exhaustion if grants are allocated for both links simultaneously.

The effectiveness of SCell activation and deactivation depends on the accuracy of these reports. If PHR reporting does not accurately reflect the UE's power distribution across cells, it can lead to suboptimal scheduling decisions, inefficient resource utilization, and degraded network performance. Ensuring that PHR calculations align with practical deployment conditions is critical for maintaining stable SCell activation and maximizing network efficiency.

In some aspects, a modem or device may exhibit an issue with the PHR mechanism in the UE when operating with a SCell. The UE, configured for SCell operation, reports its available PHR across both the PCell and SCell. While the PCell PHR is based on actual transmission data, the SCell PHR is estimated using the Sounding Reference Signal (SRS) since no uplink grant is initially available. As an example, when the network activates the SCell, the UE may report a PHR of 27 for PCell and an inflated PHR of 61 for SCell. This incorrect SCell PHR may lead the network to allocate a higher transmission grant for the SCell in addition to a reasonable grant for the PCell. However, since the UE has already exhausted its total transmission power on the PCell, it cannot utilize the additional SCell grant, which results in a Discontinuous Transmission (DTX) event. As a result, the network detects a lack of SCell transmissions and deactivates the SCell. Subsequently, the network reactivates the SCell, only for the same issue to repeat—incorrectly high PHR reports from the UE led to excessive grants on the SCell, power exhaustion on the PCell, and no actual transmission on the SCell. This cycle of activation and deactivation will persist, preventing the network from effectively utilizing the SCell to balance the uplink load. The overall effect is that the SCell feature is rendered ineffective in deployment, leading to suboptimal throughput and power spectral efficiency, as the uplink load cannot be properly distributed across cells.

Accordingly, the present disclosure describes a carrier aggregation mechanism that dynamically enables SCell activation based on UE-reported Buffer Status Reports (BSR) and PHR reports. The goal is to provide more accurate PHR reporting to improve throughput, latency, and power spectral efficiency. To achieve this, the UE initially calculates the SCell PHR for an SCell using a combination of the PCell PHR as a baseline with adjustments based on SCell-specific conditions. If the estimated path loss on SCell is similar to PCell, the same PHR value can be reported. However, if the path loss differs significantly, a weighted adjustment should be applied to the initial PHR. Additionally, after receiving actual uplink grants on the SCell, the reported PHR should be refined based on real transmission data, ensuring a more accurate power estimate.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

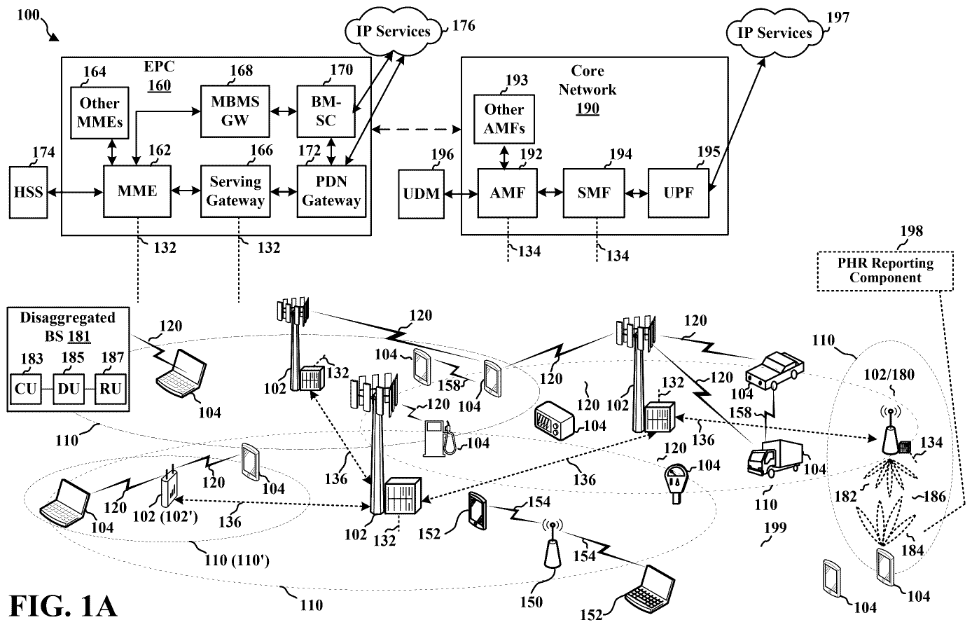

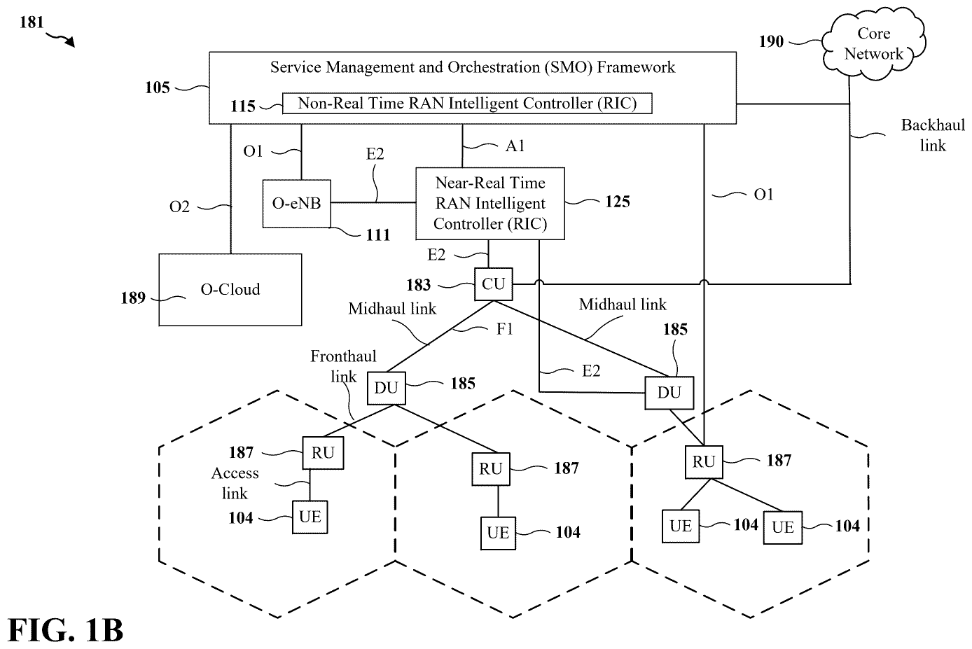

FIG. 1A is a diagram illustrating an example of a wireless communications system and an access network 100. The wireless communications system (also referred to as a wireless wide area network (WWAN)) includes network devices 102, UE(s) 104, an Evolved Packet Core (EPC) 160, and another core network 190 (e.g., a 5G Core (5GC)). The network devices 102 may include macrocells, such as high power cellular network devices, and/or small cells, such as low power cellular network devices(including femtocells, picocells, and microcells). In some aspects, the network device may include a base station (BS).

The network devices 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The network devices 102 configured for 5G New Radio (NR), which may be collectively referred to as the Next Generation Radio Access Network (RAN) (NG-RAN), may interface with a core network 190 through second backhaul links 134. In addition to other functions, the network devices 102 may perform one or more of: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, Multimedia Broadcast Multicast Service (MBMS), subscriber and equipment trace, RAN information management (RIM), paging, positioning, and delivery of warning messages.

In some aspects, the network devices 102 may communicate directly or indirectly (e.g., through the EPC 160 or core network 190) with each other over third backhaul links 136 (e.g., X2 interface). The first backhaul links 132, the second backhaul links 134, and the third backhaul links 136 may be wired, wireless, or some combination thereof. At least some of the network devices 102 may be configured for integrated access and backhaul (IAB). Accordingly, such network devices may wirelessly communicate with other network devices, which also may be configured for IAB.

At least some of the network devices 102 configured for IAB may have a split architecture including multiple units, some or all of which may be collocated or distributed and which may communicate with one another.

The network devices 102 may wirelessly communicate with the UEs 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.).

A UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Each of the network devices 102 may provide communication coverage for a respective geographic coverage area 110, which may also be referred to as a “cell.” Potentially, two or more geographic coverage areas 110 may at least partially overlap with one another, or one of the geographic coverage areas 110 may contain another of the geographic coverage areas. For example, the small cell 102′ may have a coverage area 110′ that overlaps with the coverage area 110 of one or more macro network devices 102. A network that includes both small cells and macrocells may be known as a heterogeneous network. A heterogeneous network may also include Home Evolved Node BS (eNBs) (HeNBs), which may provide service to a restricted group known as a closed subscriber group (CSG).

The communication links 120 between the network devices 102 and the UEs 104 may include uplink (also referred to as reverse link) transmissions from a UE 104 to a network device 102 and/or downlink (also referred to as forward link) transmissions from a network device 102 to a UE 104. The communication links 120 may use multiple-input and multiple-output (MIMO) antenna technology, including spatial multiplexing, beamforming, and/or transmit diversity. Wireless links or radio links may be on one or more carriers, or component carriers (CCs). The network devices 102 and/or UEs 104 may use spectrum up to Y megahertz (MHz) (e.g., Y may be equal to or approximately equal to 5, 10, 15, 20, 100, 400, etc.) bandwidth per carrier allocated in a carrier aggregation of up to a total of Yx MHz (e.g., x CCs) used for transmission in each direction. The CCs may or may not be adjacent to each other. Allocation of CCs may be asymmetric with respect to downlink and uplink (e.g., more or fewer CCs may be allocated for downlink than for uplink).

The CCs may include a primary CC and one or more secondary CCs. A primary CC may be referred to as a PCell and each secondary CC may be referred to as a SCell. The PCell may also be referred to as a “serving cell” when the UE is known both to a network device at the access network level and to at least one core network entity (e.g., AMF and/or MME) at the core network level, and the UE may be configured to receive downlink control information in the access network (e.g., the UE may be in an RRC Connected state). In some instances, in which carrier aggregation is configured for the UE, each of the PCell and the one or more SCells may be a serving cell.

Certain UEs 104 may communicate with each other using device-to-device (D2D) communication link 158. The D2D communication link 158 may use the downlink/uplink WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (or “mmWave” or simply “mmW”) band in documents and articles, despite being different from the extremely high frequency (EHF) band (30 GHz-300 GHz) which is identified by the International Telecommunications Union (ITU) as a “millimeter wave” band. In some aspects, “mmW” or “near-mmW” may additionally or alternatively refer to a 60 GHz frequency range, which may include multiple channels outside of 60 GHz. For example, a 60 GHz frequency band may refer to a set of channels spanning from 57.24 GHz to 70.2 GHz.

In view of the foregoing, unless specifically stated otherwise, the term “sub-6 GHz,” “sub-7 GHz,” and the like, to the extent used herein, may broadly represent frequencies that may be less than 6 GHz, frequencies that may be less than 7 GHz, frequencies that may be within FR1, and/or frequencies that may include mid-band frequencies. Further, unless specifically stated otherwise, the term “millimeter wave” and other similar references, to the extent used herein, may broadly represent frequencies that may include mid-band frequencies, frequencies that may be within FR2, and/or frequencies that may be within the EHF band.

A network device 102 may be implemented as a macro network device providing a large cell or may be implemented as a small cell 102′ having a small cell coverage area. Some network devices 102 may operate in a traditional sub-6 GHz (or sub-7 GHz) spectrum, in mmW frequencies, and/or near-mmW frequencies in communication with the UE 104. When such a network device operates in mmW or near-mmW frequencies, the network device may be referred to as a mmW network device 180. The mmW network device 180 may utilize beamforming 186 with the UE 104 to compensate for the path loss and short range. The network device 180 and the UE 104 may each include a plurality of antennas, such as antenna elements, antenna panels, and/or antenna arrays to facilitate the beamforming.

The network device 180 may transmit a beamformed signal to the UE 104 in one or more transmit directions 182. The UE 104 may receive the beamformed signal from the network device 180 in one or more receive directions 184. The UE 104 may also transmit a beamformed signal to the network device 180 in one or more transmit directions. The network device 180 may receive the beamformed signal from the UE 104 in one or more receive directions. One or both of the network device 180 and/or the UE 104 may perform beam training to determine the best receive and/or transmit directions for the one or both of the network device 180 and/or UE 104. The transmit and receive directions for the network device 180 may or may not be the same. The transmit and receive directions for the UE 104 may or may not be the same.

In various different aspects, one or more of the network devices 102/180 may include and/or be referred to as a gNB, Node B, eNB, an access point, a base transceiver station, a radio network device, a radio transceiver, a transceiver function, a basic service set (BSS), an extended service set (ESS), a transmit reception point (TRP), or some other suitable terminology.

In some aspects, one or more of the network devices 102/180 may be connected to the EPC 160 and may provide respective access points to the EPC 160 for one or more of the UEs 104. The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, with the Serving Gateway 166 being connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a Packet Switch (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the network devices 102 belonging to a Multicast Broadcast Single Frequency Network (MBSFN) area broadcasting a particular service, and may be responsible for session management (start/stop) and for collecting eMBMS related charging information.

In some other aspects, one or more of the network devices 102/180 may be connected to the core network 190 and may provide respective access points to the core network 190 for one or more of the UEs 104. The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a PS Streaming Service, and/or other IP services.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, network device, or a network equipment, such as a BS, or one or more units (or one or more components) performing network device functionality, may be implemented in an aggregated or disaggregated architecture. For example, a BS (such as a Node B (NB), eNB, NR BS, 5G NB, access point (AP), a TRP, or a cell, etc.) may be implemented as an aggregated network device (also known as a standalone BS or a monolithic BS) or a disaggregated network device.

An aggregated network device may be configured to utilize a radio protocol stack that is physically or logically integrated within a single RAN node. A disaggregated network device 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also can be implemented as virtual units, i.e., a virtual central unit (VCU), a virtual distributed unit (VDU), or a virtual radio unit (VRU).

Network device-type operation or network design may consider aggregation characteristics of network device functionality. For example, disaggregated network devices may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated network device, or disaggregated RAN architecture, can be configured for wired or wireless communication with at least one other unit.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

Referring back to FIG. 1A, in certain aspects, the UE 104 may include a PHR reporting component 198 that is configured to calculate an initial PHR for a SCell based on a combination of a PHR reported for a PCell as a baseline and an estimated SCell path loss relative to the PCell. The PHR reporting component 198 may also be configured to adjust the PHR for the SCell based on subsequent actual uplink transmissions on the SCell. The PHR reporting component 198 may further be configured to dynamically adjust PHR for a specific cell based on total available UE power and network scheduling patterns.

FIG. 1B shows a diagram illustrating an example disaggregated network device 181 architecture. The disaggregated network device 181 architecture may include one or more CUs 183 that can communicate directly with core network 190 via a backhaul link, or indirectly with the core network 190 through one or more disaggregated network device units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUs 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 183. The CU 183 may be configured to handle user plane functionality (i.e., Central Unit User Plane (CU-UP)), control plane functionality (i.e., Central Unit-Control Plane (CU-CP)), or a combination thereof. In some implementations, the CU 183 can be logically split into one or more CU-UP units and one or more CU-CP units. The CU-UP unit can communicate bidirectionally with the CU-CP unit via an interface, such as the E1 interface when implemented in an O-RAN configuration. The CU 183 can be implemented to communicate with the DU 185, as necessary, for network control and signaling.

The DU 185 may correspond to a logical unit that includes one or more network device functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 185 may further host one or more low PHY layers. Each layer (or module) can be implemented with an interface configured to communicate signals with other layers (and modules) hosted by the DU 185, or with the control functions hosted by the CU 183.

Lower-layer functionality can be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 187 can be implemented to handle over the air (OTA) communication with one or more UEs 104. In some implementations, real-time and non-real-time aspects of control and user plane communication with the RU(s) 187 can be controlled by the corresponding DU 185. In some scenarios, this configuration can enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements can include, but are not limited to, CUs 183, DUs 185, RUs 187 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

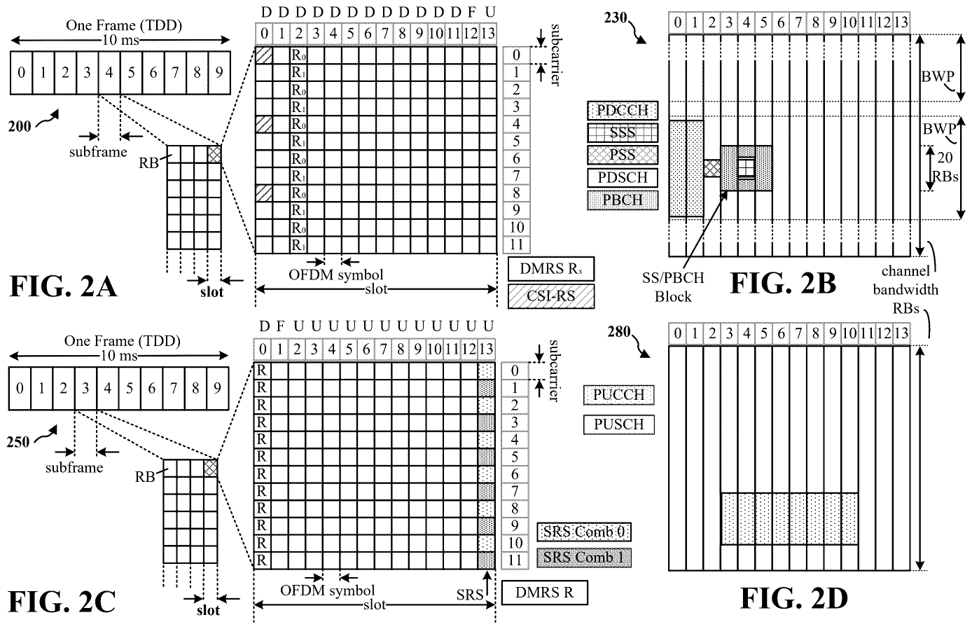

FIG. 2A is a diagram illustrating an example of a first subframe 200 within a 5G NR frame structure. FIG. 2B is a diagram illustrating an example of downlink channels within a 5G NR subframe 230. FIG. 2C is a diagram illustrating an example of a second subframe 250 within a 5G NR frame structure. FIG. 2D is a diagram illustrating an example of uplink channels within a 5G NR subframe 280. The 5G NR frame structure may be frequency division duplexed (FDD) in which for a particular set of subcarriers (carrier system bandwidth), subframes within the set of subcarriers are dedicated for either downlink or uplink, or may be time division duplexed (TDD) in which for a particular set of subcarriers (carrier system bandwidth), subframes within the set of subcarriers are dedicated for both downlink and uplink. In the examples provided by FIGS. 2A and 2C, the 5G NR frame structure is assumed to be TDD, with subframe 4 being configured with slot format 28 (with mostly downlink), where D is downlink, U is uplink, and F is flexible for use between downlink/uplink, and subframe 3 being configured with slot format 34 (with mostly uplink). While subframes 3, 4 are shown with slot formats 34, 28, respectively, any particular subframe may be configured with any of the various available slot formats 0-61. Slot formats 0, 1 are all downlink, uplink, respectively. Other slot formats 2-61 include a mix of downlink, uplink, and flexible symbols. UEs are configured with the slot format (dynamically through downlink control information (DCI), or semi-statically/statically through RRC signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on downlink may be cyclic prefix (CP) orthogonal frequency-division multiplexing (OFDM) (CP-OFDM) symbols. The symbols on uplink may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2μ*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs). Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry at least one pilot signal, such as a reference signal (RS), for the UE. Broadly, RSs may be used for beam training and management, tracking and positioning, channel estimation, and/or other such purposes. In some configurations, an RS may include at least one demodulation RS (DM-RS) (indicated as Rx for one particular configuration, where 100x is the port number, but other DM-RS configurations are possible) and/or at least one channel state information (CSI) RS (CSI-RS) for channel estimation at the UE. In some other configurations, an RS may additionally or alternatively include at least one beam measurement (or management) RS (BRS), at least one beam refinement RS (BRRS), and/or at least one phase tracking RS (PT-RS).

FIG. 2B illustrates an example of various downlink channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. A UE (such as a UE 104 of FIG. 1A) may use the PSS to determine subframe/symbol timing and a physical layer identity. A secondary synchronization signal (SSS) may be within symbol 4 of particular subframes of a frame. A UE (such as a UE 104 of FIG. 1A) may use the SSS to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the network device. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a network device for channel quality estimation to enable frequency-dependent scheduling on the uplink.

FIG. 2D illustrates an example of various uplink channels within a subframe of a frame. The PUCCH may be located as indicated in one configuration. The PUCCH carries uplink control information (UCI), which may include a scheduling request (SR), a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

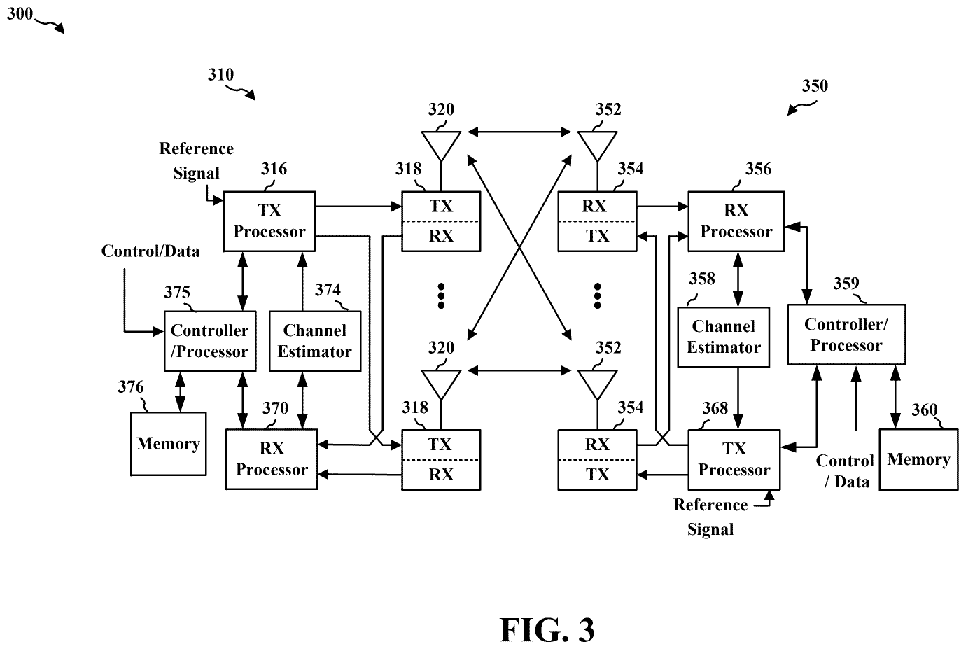

FIG. 3 is a block diagram of a network device 310 in communication with a UE 350 in an access network 300. In the downlink, IP packets from the EPC 160 may be provided to a controller/processor 375. The controller/processor 375 implements Layer 2 (L2) and Layer 3 (L3) functionality. L3 includes an RRC layer, and L2 includes a service data adaptation protocol (SDAP) layer, a packet data convergence protocol (PDCP) layer, an RLC layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement Layer 1 (L1) functionality associated with various signal processing functions. L1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially pre-coded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate a radio frequency (RF) carrier with a respective spatial stream for transmission.

At the UE 350, each receiver 354RX receives a signal through at least one respective antenna 352. Each receiver 354RX recovers information modulated onto an RF carrier and provides the information to the receive (RX) processor 356. The TX processor 368 and the RX processor 356 implement L1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the network device 310. These soft decisions may be based on channel estimates computed by the channel estimator 358. The soft decisions are then decoded and deinterleaved to recover the data and control signals that were originally transmitted by the network device 310 on the physical channel. The data and control signals are then provided to the controller/processor 359, which implements L3 and L2 functionality.

The controller/processor 359 can be associated with a memory 360 that stores program codes and data. The memory 360 may be referred to as a computer-readable medium. In the uplink, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the downlink transmission by the network device 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the network device 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The uplink transmission is processed at the network device 310 in a manner similar to that described in connection with the receiver function at the UE 350. Each receiver 318RX receives a signal through at least one respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the uplink, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the coverage extension component 198 of FIG. 1A.

At least one of the TX processor 368, the RX processor 356, and the controller/processor 359 may be configured to perform aspects in connection with the coverage extension component 199 of FIG. 1A.

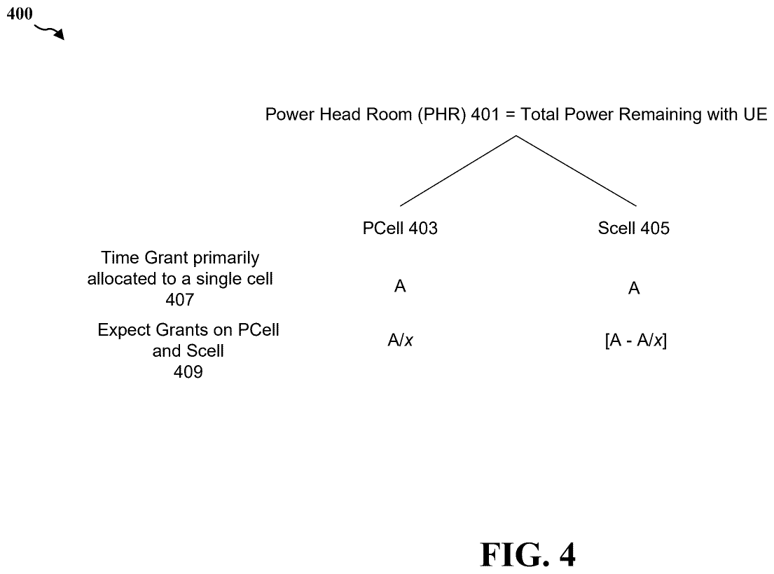

FIG. 4 illustrates an example resource allocation in a wireless communication system. Example 400 shows how a total PHR 401 available at a UE will be reported across cells based on network scheduling. In particular, the UE can report PHR in different ways depending how grants are assigned. If the network entity mostly grants data transmission on one link 407, the UE can report PHR A on both PCell 403 and SCell 405, ensuring maximum data transmission within power limits. If the network entity frequently grants data transmission across both links 409 (e.g., PCell and SCell), the UE can report PHR A/x on PCell and A(1-1/x) on SCell, optimizing data drainage while maintaining power limits.

The value of “A” represents the total available power that the UE can utilize for transmission across different cells while staying within its power constraints. The value of “x” is controlled by the UE and may be determined by several factors affecting power spectral efficiency (PSE), including at least path loss experienced on each link, BLER experienced on each link, frequency band of operation, and power spectral efficiency on each link.

In some aspects, the value of “x” can be further refined by taking into account an instantaneous network entity scheduler behavior, allowing for dynamic adjustments based on real-time grant allocations. Additionally, a Low Pass Filter (LPF) mechanism can be applied to smooth fluctuations in grant patterns over time, considering both the initial buffer levels and the continuous buffer dynamics as a function of grant availability. This approach ensures a more efficient balance between power spectral efficiency and throughput, adapting to network conditions while optimizing overall transmission performance.

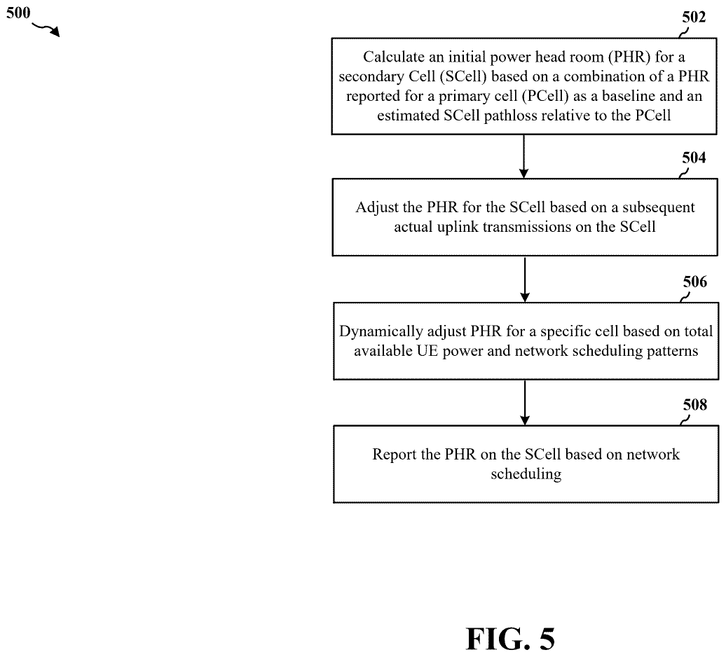

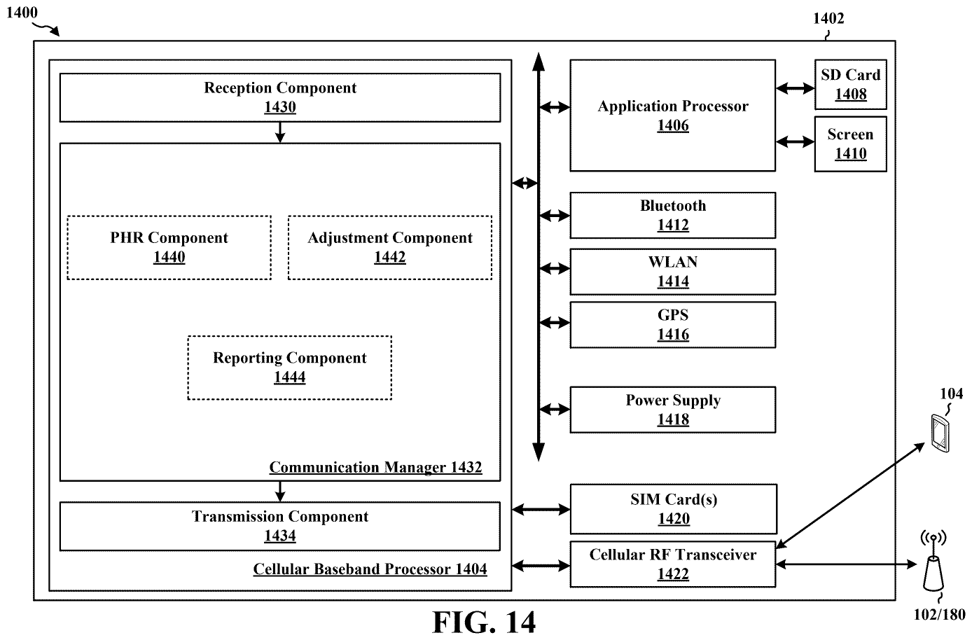

FIG. 5 is a flowchart of a method of wireless communication. The method 500 may be performed by a UE (e.g., the UE 104; the apparatus 1402 shown in FIG. 14). Specifically, the method may be performed by one or more memories, processors, and RF front ends (e.g., the memory 360, controller/processor 359, transmitter 354TX, receiver 354RX, antenna 352, etc. of FIG. 3). Optional aspects are illustrated with a dashed line.

At 502, the UE may calculate an initial PHR for a SCell based on a combination of a

PHR reported for a PCell as a baseline and an estimated SCell path loss relative to the PCell. For example, 502 may be performed by a PHR component 1440. This approach enables the UE to derive the SCell PHR efficiently without requiring an independent direct measurement. By using the PCell PHR as a reference, the UE can quickly estimate the appropriate transmission power for the SCell, reducing computational overhead and improving power control.

At 504, the UE may adjust the PHR for the SCell based on subsequent actual uplink transmissions on the SCell. For example, 504 may be performed by an adjustment component 1442. Initially, the PHR for the SCell may be estimated using the PCell as a reference, but as the UE begins transmitting on the SCell, it can gather real-time transmission data, including actual power usage and path loss conditions. By incorporating these real-world transmission parameters, the UE can update the PHR dynamically, ensuring more accurate power control and efficient resource allocation. This adjustment allows for better adaptation to changing channel conditions, reducing power inefficiencies, minimizing interference, and improving uplink performance in multi-cell scenarios, particularly in Carrier Aggregation (CA) deployments.

At 506, the UE may dynamically adjust PHR for a specific cell based on total available UE power and network scheduling patterns. For example, 506 may be performed by an adjustment component 1442. Since the UE has a limited power budget, it must distribute its transmission power efficiently across multiple serving cells, especially in CA scenarios. By continuously monitoring its total available power, the UE can adjust the PHR to reflect realistic power constraints, preventing overestimation that could lead to transmission failures or underutilization that could impact uplink performance. Additionally, the network scheduling patterns—such as the allocation of uplink resources across different cells—can influence the UE's power distribution strategy. If more resources are scheduled on a particular cell, the UE may adjust its PHR to account for the increased power demand, ensuring stable and efficient uplink transmission.

At 508, the UE may report the PHR on the SCell based on network scheduling to ensure efficient uplink power control and resource allocation. For example, 504 may be performed by a reporting component 1444. Since the network dynamically schedules uplink transmissions across multiple serving cells, the UE adapts its PHR reporting to reflect the actual transmission conditions and power availability. If the network schedules uplink resources on the SCell, the UE reports the PHR to provide the network with updated insights into its remaining transmission power. Conversely, if no uplink resources are allocated to the SCell, the UE may withhold or delay PHR reporting, optimizing signaling overhead. This scheduling-aware PHR reporting enables the network to make informed power control decisions, improving transmission reliability, minimizing power inefficiencies, and enhancing overall uplink performance.

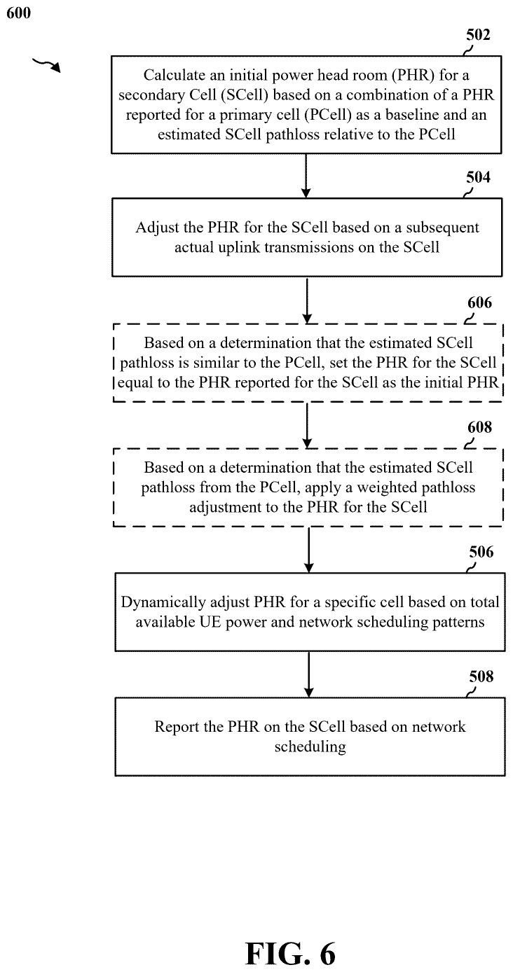

Referring to method 600 in FIG. 6, in an alternative or additional aspect, at 606, the UE may set the PHR for the SCell equal to the PHR reported for the SCell as the initial PHR based on a determination that the estimated SCell path loss is similar to the PCell. This approach allows the UE to streamline the initial power estimation process, avoiding unnecessary calculations and measurements. By assuming that both cells experience comparable propagation conditions, the UE can use the PHR for the PCell as a reliable baseline for the SCell, enabling faster power allocation and reducing computational complexity. This method is particularly beneficial in CA scenarios where the SCell and PCell operate in similar frequency bands or geographic conditions, ensuring efficient uplink power management while minimizing signaling overhead.

In this additional aspect, at 608, the UE may apply a weighted path loss adjustment to the PHR for the SCell based on a determination that the estimated SCell path loss differs from the PCell. Instead of assuming identical path loss conditions, the UE refines the PHR calculation by incorporating a weighted adjustment factor that accounts for variations in propagation characteristics between the two cells. This adjustment ensures a more accurate representation of the UE's available transmission power for the SCell, leading to better uplink power control and resource allocation. By dynamically tuning the weight based on real-time channel conditions and historical data, the UE optimizes power distribution across aggregated cells, minimizing transmission errors and improving overall network efficiency in CA scenarios.

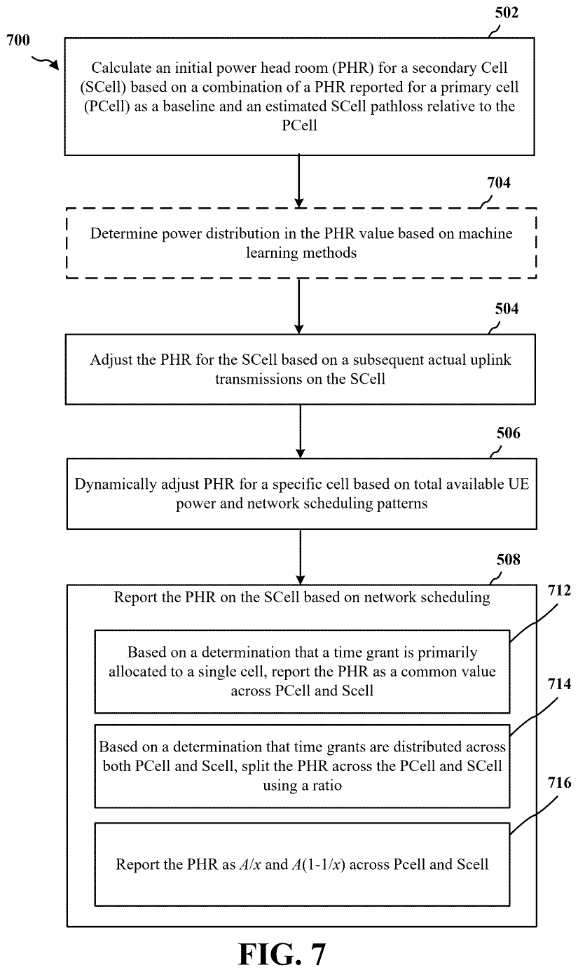

Referring to method 700 in FIG. 7, in an alternative or additional aspect, at 704, the UE may determine power distribution in the PHR value based on Machine Learning (ML) methods. The power distribution in a communication system, or power reported across cells, may be determined using ML methods. The power split between cells, or the power reported across cells, may be determined using machine learning techniques that are local to the UE, based on UE intelligence and internal inputs from one or more model entities, based on network (NW) inference, or in close coordination with a NW entity. The power distribution in a communication system can thus be efficiently determined using ML models that may operate internally within the receiver, in coordination with the transmitter, or be fully controlled by the transmitter using ML-based decision models.

When handled internally by the UE, the ML logic autonomously optimizes power allocation based on real-time channel conditions, historical data patterns, and/or available model inputs. In a coordinated approach, both the UE and NW exchange relevant information to dynamically enhance power distribution. Alternatively, a NW-controlled ML model may leverage broader network insights, predictive analytics, and global optimization strategies to allocate power efficiently across multiple users or network elements.

In some aspects, an AI-native approach to power reporting may be employed based on flexibility provided by the network, including a permitted range of power split or reporting across cells or UEs. Such flexibility enables adaptive reporting strategies that align with the network objectives while allowing intelligent UE behavior. These ML- and AI-driven approaches ensure adaptive, intelligent, and efficient power management, enhancing overall system performance and energy efficiency in modern wireless networks.

In an alternative or additional aspect, at 712, the reporting block at 508 further includes reporting the PHR as a common value across PCell and SCell based on a determination that a time grant is primarily allocated to a single cell. In such scenarios, since the UE's transmission power is primarily utilized for one cell, the available power for the other cell remains relatively unchanged, making it efficient to report a unified PHR. This approach reduces signaling overhead and simplifies power management, allowing the network to make informed scheduling and power control decisions without redundant or unnecessary PHR updates.

In some aspects, splitting the PHR across the PCell and SCell using a ratio based on a determination that time grants are distributed across both PCell and SCell. As an example, referring back to FIG. 4, the ratio may be based on distributing PHR A/x on PCell and A(1-1/x) on SCell.

At 714, the UE may split the PHR across the PCell and SCell using a ratio based on a determination that time grants are distributed across both PCell and SCell. When the network schedules uplink transmissions across multiple cells, the UE determines how its total available power is shared between the PCell and SCell. Instead of reporting a common PHR, the UE splits the PHR values (see 716 below) according to the resource distribution, ensuring that each cell's reported power availability accurately represents its share of the transmission power.

Specifically, at 716, the UE may report the PHR as A/x and A(1-1/x) across PCell and SCell. As an example, referring back to FIG. 4, if the network entity frequently grants data transmission across both links 409, the UE can report PHR A/x on PCell and A(1-1/x) on SCell, optimizing data drainage while maintaining power limits.

In some aspects, the value of x is based on at least one of: path loss experienced on each link, block error rate (BLER) experienced on each link, frequency band of operation, neighbor cells impact on each beam, or power spectral efficiency on each link. Path loss accounts for signal degradation over distance and obstacles, helping optimize power allocation. BLER provides real-time feedback on link reliability, ensuring adjustments improve data transmission efficiency. The frequency band of operation impacts propagation characteristics, influencing how power should be distributed across different bands. Neighbor cell interference affects signal quality, requiring adjustments to mitigate cross-cell impact on beam performance. Power spectral efficiency helps balance power allocation to maximize data throughput.

In some aspects, the value of x is refined based on an instantaneous scheduling behavior from a network entity or by applying a low pass filter mechanism to historical grant patterns. When adjusting based on instantaneous scheduling, the system quickly adapts to real-time network resource allocations, ensuring optimal power distribution and transmission efficiency. Alternatively, by using a low-pass filter, the system smooths fluctuations in historical grant patterns, preventing abrupt changes and ensuring a more stable, predictive power control approach. This refinement method balances responsiveness and stability, optimizing performance while adapting to network conditions.

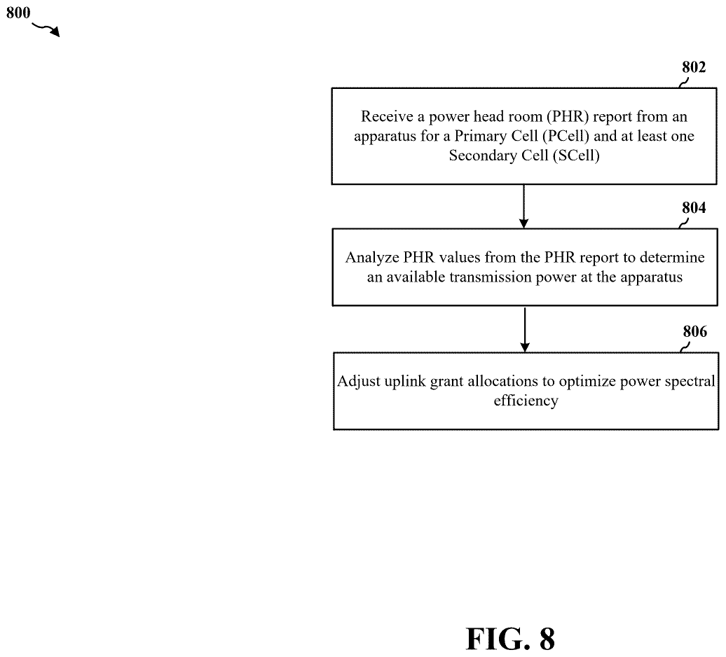

FIG. 8 is a flowchart 800 of a method of wireless communication. The method may be performed by a network entity or base station (e.g., the base station 102/180; the apparatus 1502). Specifically, the method may be performed by one or more memories, processors, and RF front ends (e.g., the memory 376, controller/processor 375, transmitter 318TX, receiver 319RX, antenna 320, etc. of FIG. 3). Optional aspects are illustrated with a dashed line.

At 802, the network entity may receive a PHR report from an apparatus for a PCell and at least one SCell. For example, 802 may be performed by a PHR component 1440. This report provides crucial insights into the UE's power budget, helping the network optimize uplink scheduling, power control, and resource allocation. By receiving PHR reports for both the PCell and SCell, the network can make informed decisions to enhance transmission efficiency, minimize power imbalances, and improve overall system performance, particularly in CA scenarios.

At 804, the network entity may determine an available transmission power at a UE by analyzing PHR values from the PHR report. For example, 804 may be performed by a PHR component 1540.

At 806, the network entity may adjust uplink grant allocations based on the available transmission power at the UE to optimize power spectral efficiency. For example, 806 may be performed by an allocation component 1542.

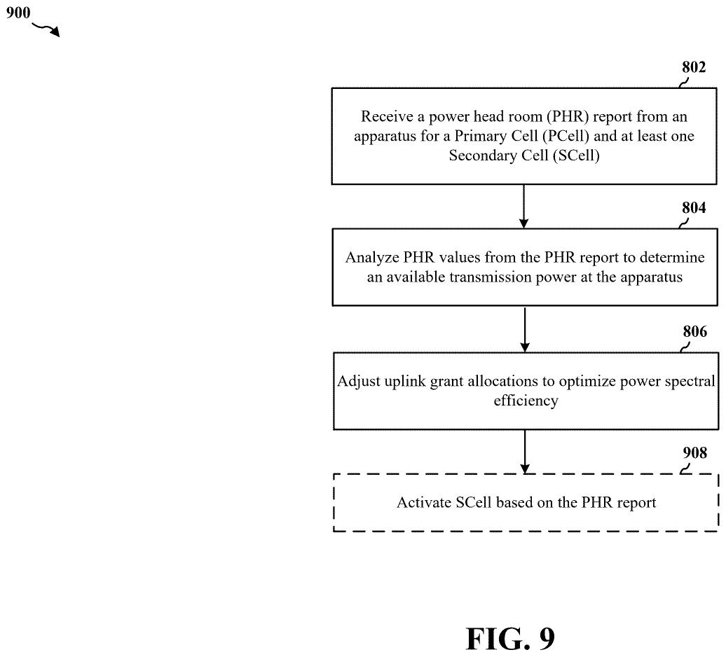

Referring to method 900 in FIG. 9, in an alternative or additional aspect, at 908, the network entity may activate SCell based on the PHR report. By analyzing the PHR report from the UE, the network determines whether the UE has sufficient available transmission power to support additional SCells without compromising signal quality or exceeding power constraints. If the PHR indicates adequate headroom, the network can activate the SCell to enhance data throughput and improve overall capacity in CA scenarios.

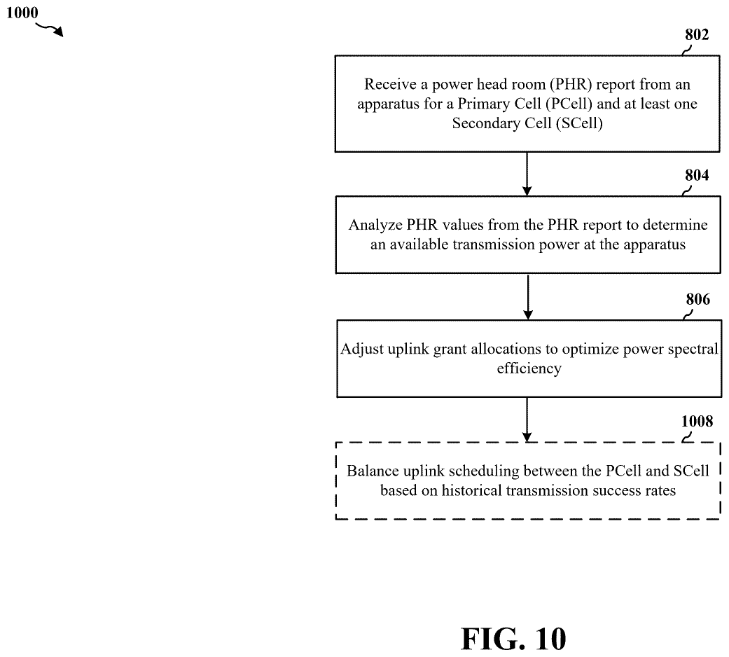

Referring to method 1000 in FIG. 10, in an alternative or additional aspect, at 1008, the network entity may balance uplink scheduling between the PCell and SCell based on historical transmission success rates. By evaluating past uplink performance, including factors such as BLER, power headroom availability, and transmission reliability, the network can adjust scheduling decisions to favor the cell that offers better stability and efficiency. If a particular cell has experienced frequent transmission failures, the network may allocate more resources to the more reliable cell to ensure consistent data transmission.

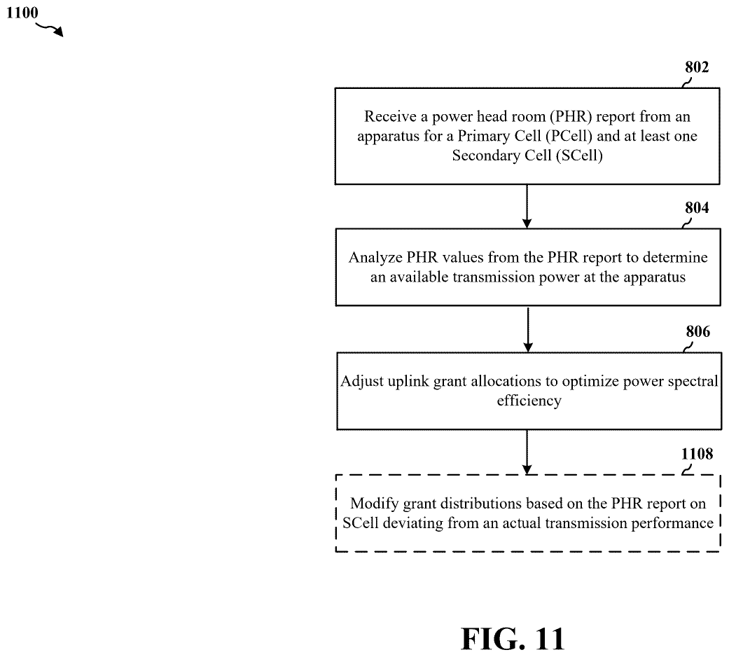

Referring to method 1100 in FIG. 11, in an alternative or additional aspect, at 1108, the network entity may modify grant distributions based on the PHR report on SCell deviating from an actual transmission performance. If the reported PHR suggests that the UE has sufficient power for transmission, but actual uplink performance indicates power limitations—such as high BLER or reduced signal quality—the network can adjust future uplink grants accordingly. Conversely, if the UE consistently underutilizes allocated power, the network may redistribute resources to optimize efficiency.

In some aspects, the deviations correspond to at least one of: path loss difference between the PCell and SCell as reported by the apparatus, measured BLER on each uplink transmission, or network congestion levels and interference from neighboring cells. If the reported PHR does not accurately reflect transmission conditions, it may be due to differences in path loss, where the SCell experiences greater attenuation than initially estimated. Additionally, a high BLER on uplink transmissions indicates poor link reliability, suggesting that the available power is insufficient for successful data transmission. Network congestion and interference from neighboring cells can also impact transmission performance by reducing signal quality and limiting available uplink resources.

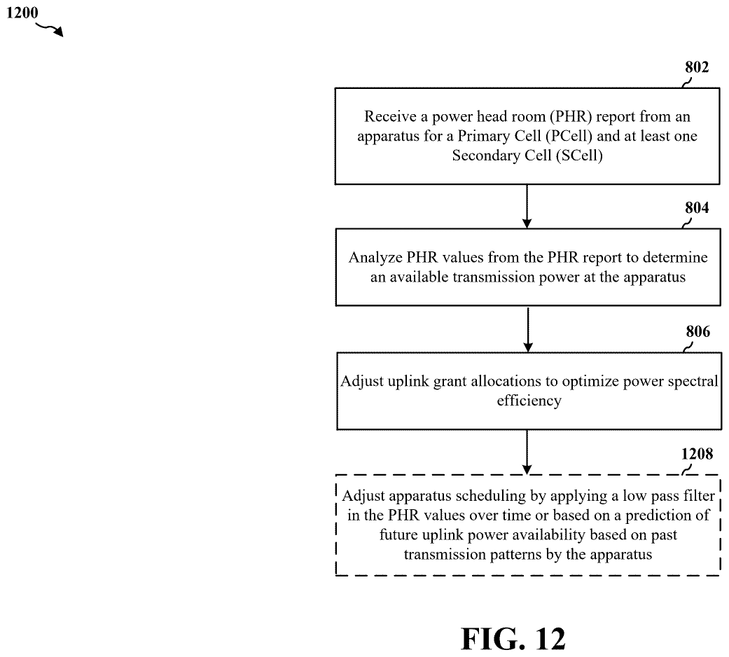

Referring to method 1200 in FIG. 12, in an alternative or additional aspect, at 1208, the network entity may adjust apparatus scheduling by applying a low pass filter in the PHR values over time or based on a prediction of future uplink power availability based on past transmission patterns by the user equipment. Using a low-pass filter, the system smooths out short-term fluctuations in PHR values, preventing abrupt scheduling changes that could lead to inefficiencies or instability in uplink power control. Alternatively, by analyzing historical transmission data, including power usage trends, grant utilization, and link reliability, the network can forecast the UE future power availability and adjust scheduling decisions proactively.

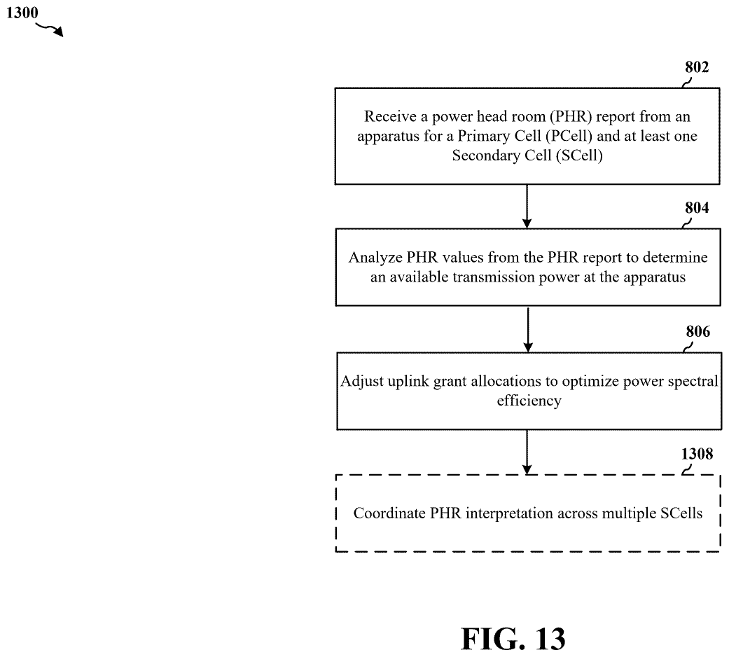

Referring to method 1300 in FIG. 13, in an alternative or additional aspect, at 1308, the network entity may coordinate PHR interpretation across multiple SCells by assigning dynamic weights to the PHR values from different cells based on a reported path loss by the apparatus, and prioritizing SCells with a lower BLER. By dynamically weighting PHR values, the network accounts for variations in signal attenuation, ensuring that SCells experiencing higher path loss receive adjusted power considerations to maintain transmission efficiency. Additionally, prioritizing SCells with lower BLER allows the network to allocate uplink resources more effectively, favoring links with better transmission reliability while preventing excessive resource allocation to unstable connections. This adaptive interpretation of PHR values enhances uplink power distribution, improves spectral efficiency, and optimizes network performance.

FIG. 14 is a diagram 1400 illustrating an example of a hardware implementation for an apparatus 1402. The apparatus 1402 may be a UE (the UE 104, 350) or similar device, or the apparatus 1402 may be a component of a UE or similar device. The apparatus 1402 may include a cellular baseband processor 1404 (also referred to as a modem) and/or a cellular RF transceiver 1422, which may be coupled together and/or integrated into the same package, component, circuit, chip, and/or other circuitry.

In some aspects, the apparatus 1402 may accept or may include one or more subscriber identity modules (SIM) cards 1420, which may include one or more integrated circuits, chips, or similar circuitry, and which may be removable or embedded. The one or more SIM cards 1420 may carry identification and/or authentication information, such as an international mobile subscriber identity (IMSI) and/or IMSI-related key(s). Further, the apparatus 1402 may include one or more of an application processor 1406 coupled to a secure digital (SD) card 1408 and a screen 1410, a Bluetooth module 1412, a wireless local area network (WLAN) module 1414, a Global Positioning System (GPS) module 1416, and/or a power supply 1418.

The cellular baseband processor 1404 communicates through the cellular RF transceiver 1422 with the UE 104, 350 and/or network device 102/180. The cellular baseband processor 1404 may include a computer-readable medium/memory. The computer-readable medium/memory may be non-transitory. The cellular baseband processor 1404 is responsible for general processing, including the execution of software stored on the computer-readable medium/memory. The software, when executed by the cellular baseband processor 1404, causes the cellular baseband processor 1404 to perform the various functions described supra. The computer-readable medium/memory may also be used for storing data that is manipulated by the cellular baseband processor 1404 when executing software. The cellular baseband processor 1404 further includes a PHR component 1440, an adjustment component 1442, and a reporting component 1444. The communication manager 1432 includes the one or more illustrated components. The components within the communication manager 1432 may be stored in the computer-readable medium/memory and/or configured as hardware within the cellular baseband processor 1404.

In the context of FIG. 3, the cellular baseband processor 1404 may be a component of the UE 350 and may include the memory 360 and/or at least one of the TX processor 368, the RX processor 356, and/or the controller/processor 359. In one configuration, the apparatus 1402 may be a modem chip and/or may be implemented as the cellular baseband processor 1404, while in another configuration, the apparatus 1402 may be the entire UE (e.g., the UE 350 of FIG. 3) and may include some or all of the abovementioned components, circuits, chips, and/or other circuitry illustrated in the context of the apparatus 1402. In one configuration, the cellular RF transceiver 1422 may be implemented as at least one of the transmitter 354TX and/or the receiver 354RX.

The reception component 1430 may be configured to receive signaling on a wireless channel, such as signaling from a network device 102/180 or UE 104. The transmission component 1434 may be configured to transmit signaling on a wireless channel, such as signaling to a network device 102/180 or UE 104. The communication manager 1432 may coordinate or manage some or all wireless communications by the apparatus 1402, including across the reception component 1430 and the transmission component 1434.

The reception component 1430 may provide some or all data and/or control information included in received signaling to the communication manager 1432, and the communication manager 1432 may generate and provide some or all of the data and/or control information to be included in transmitted signaling to the transmission component 1434. The communication manager 1432 may include the various illustrated components, including one or more components configured to process received data and/or control information, and/or one or more components configured to generate data and/or control information for transmission.

The communication manager 1432 includes a PHR component 1440 that is configured to calculate an initial PHR for a SCell based on a combination of a PHR reported for a PCell as a baseline and an estimated SCell path loss relative to the PCell, e.g., as described in connection with operation 502 from FIG. 5.

In some aspects, the communication manager 1432 also includes an adjustment component 1442 that is configured to adjust the PHR for the SCell based on subsequent actual uplink transmissions on the SCell, e.g., as described in connection with operation 504 from FIG. 5. The adjustment component 1442 is also configured to dynamically adjust PHR for a specific cell based on total available UE power and network scheduling patterns, e.g., as described in connection with operation 506 from FIG. 5.

In some aspects, the communication manager 1432 also includes a reporting component 1444 that is configured to report the PHR on the SCell based on network scheduling, e.g., as described n connection with operation 508 from FIG. 5.

The apparatus 1402 may include additional components that perform some or all of the blocks, operations, signaling, etc. of the algorithm(s) in the aforementioned call flow diagram(s) and/or flowchart(s) of FIGS. 4-7. As such, some or all of the blocks, operations, signaling, etc. in the aforementioned call flow diagram(s) and/or flowchart(s) of FIGS. 4-7 may be performed by one or more components and the apparatus 1402 may include one or more such components. The components may be one or more hardware components specifically configured to carry out the stated processes/algorithm, implemented by a processor configured to perform the stated processes/algorithm, stored within a computer-readable medium for implementation by a processor, or some combination thereof.

The aforementioned means may be one or more of the aforementioned components of the apparatus 1402 configured to perform the functions recited by the aforementioned means. As described supra, the apparatus 1402 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

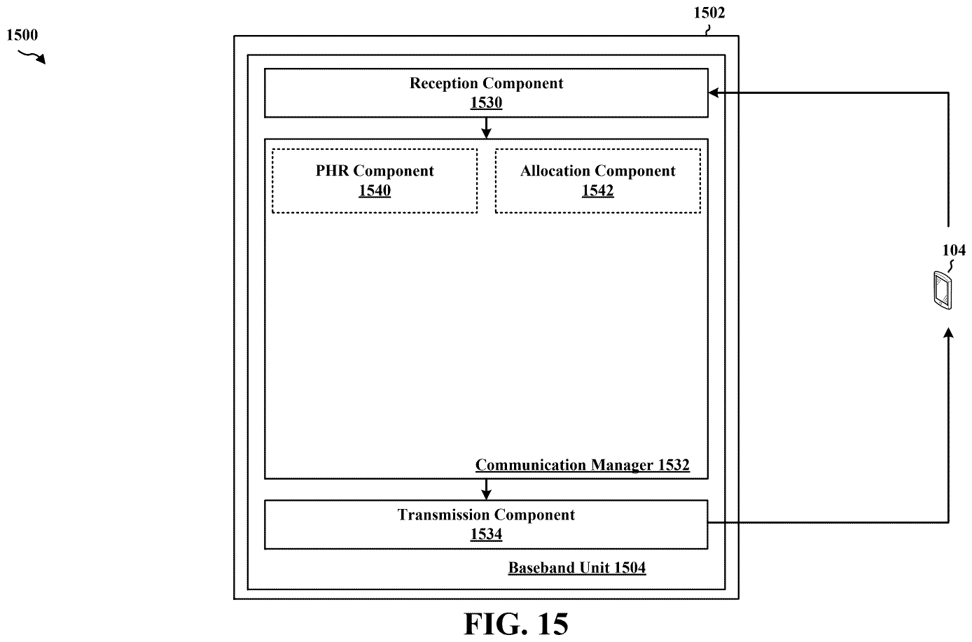

FIG. 15 is a diagram 1500 illustrating an example of a hardware implementation for an apparatus 1502. The apparatus 1502 may be a base station or similar device or system, or the apparatus 1502 may be a component of a base station or similar device or system. The apparatus 1502 may include a baseband unit 1504. The baseband unit 1504 may communicate through a cellular RF transceiver. For example, the baseband unit 1504 may communicate through a cellular RF transceiver with a UE 104, such as for downlink and/or uplink communication, and/or with a base station 102/180, such as for IAB.

The baseband unit 1504 may include a computer-readable medium/memory, which may be non-transitory. The baseband unit 1504 is responsible for general processing, including the execution of software stored on the computer-readable medium/memory. The software, when executed by the baseband unit 1504, causes the baseband unit 1504 to perform the various functions described supra. The computer-readable medium/memory may also be used for storing data that is manipulated by the baseband unit 1504 when executing software. The baseband unit 1504 further includes a reception component 1530, a communication manager 1532, and a transmission component 1534. The communication manager 1532 includes the one or more illustrated components. The components within the communication manager 1532 may be stored in the computer-readable medium/memory and/or configured as hardware within the baseband unit 1504. The baseband unit 1504 may be a component of the base station 410 and may include the memory 476 and/or at least one of the TX processor 416, the RX processor 470, and the controller/processor 475.

The reception component 1530 may be configured to receive signaling on a wireless channel, such as signaling from a UE 104 or base station 102/180. The transmission component 1534 may be configured to transmit signaling on a wireless channel, such as signaling to a UE 104 or base station 102/180. The communication manager 1532 may coordinate or manage some or all wireless communications by the apparatus 1502, including across the reception component 1530 and the transmission component 1534.

The reception component 1530 may provide some or all data and/or control information included in received signaling to the communication manager 1532, and the communication manager 1532 may generate and provide some or all of the data and/or control information to be included in transmitted signaling to the transmission component 1534. The communication manager 1532 may include the various illustrated components, including one or more components configured to process received data and/or control information, and/or one or more components configured to generate data and/or control information for transmission. In some aspects, the generation of data and/or control information may include packetizing or otherwise reformatting data and/or control information received from a core network, such as the core network 190 or the EPC 160, for transmission.

The communication manager 1532 includes a PHR component 1540 that is configured to receive a PHR report from an apparatus for a PCell and at least one SCell, e.g., as described in connection with operation 802 from FIG. 8. In some aspects, the PHR component 1540 may be configured to determine an available transmission power at a user equipment (UE) by analyzing PHR values from the PHR report, e.g., as described in connection with operation 804 from FIG. 8. In some aspects, the communication manager 1532 may include an allocation component 1542 that is configured to adjust uplink grant allocations based on the available transmission power at the UE to optimize power spectral efficiency, e.g., as described in connection with operation 806 from FIG. 8.

The apparatus 1502 may include additional components that perform some or all of the blocks, operations, signaling, etc. of the algorithm(s) in the aforementioned call flow diagram(s) and/or flowchart(s) of FIGS. 8-13. As such, some or all of the blocks, operations, signaling, etc. in the aforementioned call flow diagram(s) and/or flowchart(s) of FIGS. 8-13 may be performed by a component and the apparatus 1502 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1502, and in particular the baseband unit 1504, may include means for transmitting information indicating a scheduled physical uplink control channel (PUCCH) transmission on a PUCCH resource, wherein the means for transmitting is further configured to transmit a message on a Physical Downlink Shared Channel (PDSCH) channel in a random access procedure, and to transmit a configuration indicating a number of repetitions for the scheduled PUCCH transmission in a plurality of slots prior to activation of a dedicated PUCCH resource configuration with a plurality of repetitions based on a radio resource control (RRC) message, wherein the scheduled PUCCH transmission includes a Hybrid Automatic Repeat Request (HARQ) feedback message indicating a reception status of the message, and means for obtaining the repetition for the scheduled PUCCH transmission on the PUCCH.

The aforementioned means may be one or more of the aforementioned components of the apparatus 1502 configured to perform the functions recited by the aforementioned means. As described supra, the apparatus 1502 may include the TX Processor 416, the RX Processor 470, and the controller/processor 475. As such, in one configuration, the aforementioned means may be the TX Processor 416, the RX Processor 470, and the controller/processor 475 configured to perform the functions recited by the aforementioned means.

The specific order or hierarchy of blocks or operations in each of the foregoing processes, flowcharts, and other diagrams disclosed herein is an illustration of example approaches. Based upon design preferences, the specific order or hierarchy of blocks or operations in each of the processes, flowcharts, and other diagrams may be rearranged, omitted, and/or contemporaneously performed without departing from the scope of the present disclosure. Further, some blocks or operations may be combined or omitted. The accompanying method claims present elements of the various blocks or operations in a sample order, and are not meant to be limited to the specific order or hierarchy presented.

### SOME ADDITIONAL EXAMPLES

The following examples are illustrative only and may be combined with aspects of other embodiments or teachings described herein, without limitation.

Clause 1. An apparatus for wireless communication at a user equipment (UE), comprising: at least one memory; and at least one processor coupled to the at least one memory and, based at least in part on information stored in the at least one memory, the at least one processor, individually or in combination, is configured to cause the UE to: calculate an initial power headroom report (PHR) for a secondary Cell (SCell) based on a combination of a PHR reported for a primary cell (PCell) as a baseline and an estimated SCell path loss relative to the PCell, adjust the PHR for the SCell based on subsequent actual uplink transmissions on the SCell, dynamically adjust PHR for a specific cell based on total available UE power and network scheduling patterns, and report the PHR on the SCell based on network scheduling.

Clause 2. The apparatus of clause 1, wherein the at least one processor is further configured to: based on a determination that the estimated SCell path loss is similar to the PCell, set the PHR for the SCell equal to the PHR reported for the SCell as the initial PHR.

Clause 3. The apparatus of any of the clauses 1 to 2, wherein the at least one processor is further configured to: based on a determination that the estimated SCell path loss is different from the PCell, apply a weighted path loss adjustment to the PHR for the SCell.

Clause 4. The apparatus of any of the clauses 1 to 3, wherein reporting the PHR on the SCell based on network scheduling further comprises: based on a determination that a time grant is primarily allocated to a single cell, reporting the PHR as a common value across PCell and SCell.

Clause 5. The apparatus of any of the clauses 1 to 4, wherein reporting the PHR on the SCell based on network scheduling further comprises: splitting the PHR across the PCell and SCell using a ratio based on a determination that time grants are distributed across both PCell and SCell.

Clause 6. The apparatus of any of the clauses 1 to 5, wherein the at least one processor is further configured to: reporting the PHR as A/x and A(1-1/x) across the PCell and the SCell, respectively, wherein A corresponds to available PHR at the apparatus.

Clause 7. The apparatus of any of the clauses 1 to 6, wherein a value of x is based on at least one of: path loss experienced on each link, block error rate (BLER) experienced on each link, frequency band of operation, neighbor cells impact on each beam, or power spectral efficiency on each link.

Clause 8. The apparatus of any of the clauses 1 to 7, wherein the value of x is refined based on an instantaneous scheduling behavior from a network entity or by applying a low pass filter mechanism to historical grant patterns.

Clause 9. The apparatus of any of the clauses 1 to 8, wherein the at least one processor is further configured to: determining power distribution in the PHR value based on machine learning methods.

Clause 10. An apparatus for wireless communication at a network entity, comprising: at least one memory; and at least one processor coupled to the at least one memory and, based at least in part on information stored in the at least one memory, the at least one processor, individually or in combination, is configured to cause the network entity to: receive a power headroom (PHR) report from an apparatus for a Primary Cell (PCell) and at least one Secondary Cell (SCell), determine an available transmission power at a user equipment (UE) by analyzing PHR values from the PHR report, and adjust uplink grant allocations based on the available transmission power at the UE to optimize power spectral efficiency.

Clause 11. The apparatus of clause 10, wherein the at least one processor is further configured to: activate SCell based on the PHR report.

Clause 12. The apparatus of any of the clauses 10 to 11, wherein the at least one processor is further configured to: balance uplink scheduling between the PCell and SCell based on historical transmission success rates.

Clause 13. The apparatus of any of the clauses 10 to 11, wherein the at least one processor is further configured to: modify grant distributions based on the PHR report on SCell deviating from an actual transmission performance.

Clause 14. The apparatus of any of the clauses 10 to 12, wherein the deviations correspond to at least one of: path loss difference between the PCell and SCell as reported by the apparatus, measured Block Error Rate (BLER) on each uplink transmission, or network congestion levels and interference from neighboring cells.

Clause 15. The apparatus of any of the clauses 10 to 14, wherein the at least one processor is further configured to: adjusting apparatus scheduling by applying a low pass filter in the PHR values over time or based on a prediction of future uplink power availability based on past transmission patterns by the user equipment.

Clause 16. The apparatus of any of the clauses 10 to 15, wherein the at least one processor is further configured to: coordinating PHR interpretation across multiple SCells by assigning dynamic weights to the PHR values from different cells based on a reported path loss by the apparatus, and prioritizing SCells with a lower BLER.

Clause 17. A method of wireless communication at a user equipment (UE), comprising: calculating an initial power headroom report (PHR) for a secondary Cell (SCell) based on a combination of a PHR reported for a primary cell (PCell) as a baseline and an estimated SCell path loss relative to the PCell, adjusting the PHR for the SCell based on subsequent actual uplink transmissions on the SCell, dynamically adjusting PHR for a specific cell based on a total available UE power and network scheduling patterns, and reporting the PHR on the SCell based on network scheduling.

Clause 18. The method of clause 17, further comprising: setting the PHR for the SCell equal to the PHR reported for the SCell as the initial PHR based on a determination that the estimated SCell path loss is similar to the PCell.

Clause 19. The method of any of the clauses 17 to 18, further comprising: applying a weighted path loss adjustment to the PHR for the SCell based on a determination that the estimated SCell path loss differs from the PCell.

Clause 20. The method of any of the clauses 17 to 19, wherein reporting the PHR on the SCell based on network scheduling further comprises: splitting the PHR across the PCell and SCell using a ratio based on a determination that time grants are distributed across both PCell and SCell.

The previous description is provided to enable one of ordinary skill in the art to practice the various aspects described herein. Various modifications to these aspects will be readily apparent to those having ordinary skill in the art, and the generic principles defined herein may be applied to other aspects. Thus, the claims are not intended to be limited to the aspects shown herein, but is to be accorded the full scope consistent with the language. Thus, the language employed herein is not intended to limit the scope of the claims to only those aspects shown herein, but is to be accorded the full scope consistent with the language of the claims.

As one example, the language “determining” may encompass a wide variety of actions, and so may not be limited to the concepts and aspects explicitly described or illustrated by the present disclosure. In some contexts, “determining” may include calculating, computing, processing, measuring, deriving, investigating, looking up (e.g., looking up in a table, a database or another data structure), ascertaining, resolving, selecting, choosing, establishing, and so forth. In some other contexts, “determining” may include communication and/or memory operations/procedures through which information or value(s) are acquired, such as “receiving” (e.g., receiving information), “accessing” (e.g., accessing data in a memory), “detecting,” and the like.

As another example, reference to an element in the singular is not intended to mean “one and only one” unless specifically stated, but rather “one or more.” Further, terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action or event, but rather imply that if a condition is met then another action or event will occur, but without requiring a specific or immediate time constraint or direct correlation for the other action or event to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in combination, is configured to cause the UE to:
calculate an initial power headroom report (PHR) for a secondary Cell (SCell) based on a combination of a PHR reported for a primary cell (PCell) as a baseline and an estimated SCell path loss relative to the PCell,
adjust the PHR for the SCell based on subsequent actual uplink transmissions on the SCell,
dynamically adjust PHR for a specific cell based on total available UE power and network scheduling patterns, and
report the PHR on the SCell based on network scheduling.

2. The apparatus of claim 1, wherein the at least one processor is further configured to:
based on a determination that the estimated SCell path loss is similar to the PCell, set the PHR for the SCell equal to the PHR reported for the SCell as the initial PHR.

3. The apparatus of claim 1, wherein the at least one processor is further configured to:
based on a determination that the estimated SCell path loss is different from the PCell, apply a weighted path loss adjustment to the PHR for the SCell.

4. The apparatus of claim 1, wherein reporting the PHR on the SCell based on network scheduling further comprises:
based on a determination that a time grant is primarily allocated to a single cell, reporting the PHR as a common value across PCell and SCell.

5. The apparatus of claim 4, wherein reporting the PHR on the SCell based on network scheduling further comprises:
splitting the PHR across the PCell and SCell using a ratio based on a determination that time grants are distributed across both PCell and SCell.

6. The apparatus of claim 5, wherein the at least one processor is further configured to:
reporting the PHR as a portion of available PHR at the apparatus and the remaining portion of the available PHR across the PCell and the SCell, respectively.

7. The apparatus of claim 6, wherein the remaining portion of the available PHR is based on at least one of:
path loss experienced on each link,
block error rate (BLER) experienced on each link,
frequency band of operation,
neighbor cells impact on each beam, or
power spectral efficiency on each link.

8. The apparatus of claim 7, wherein the value of x is refined based on an instantaneous scheduling behavior from a network entity or by applying a low pass filter mechanism to historical grant patterns.

9. The apparatus of claim 1, wherein the at least one processor is further configured to:
determining power distribution in the PHR value based on at least one of machine learning (ML) model or an artificial intelligence (AI)-native approach.

10. The apparatus of claim 9, wherein the at least one ML model is locally run on the UE.

11. The apparatus of claim 9, where the at least one ML model is run on a network entity.

12. The apparatus of claim 9, wherein the at least one ML model is run on both the UE and the network entity in coordination.

13. An apparatus for wireless communication at a network entity, comprising:
at least one memory; and
at least one processor coupled to the at least one memory and, based at least in part on information stored in the at least one memory, the at least one processor, individually or in combination, is configured to cause the network entity to:
receive a power headroom report (PHR) report from an apparatus for a Primary Cell (PCell) and at least one Secondary Cell (SCell),
determine an available transmission power at a user equipment (UE) by analyzing PHR values from the PHR report, and
adjust uplink grant allocations based on the available transmission power at the UE to optimize power spectral efficiency.

14. The apparatus of claim 13, wherein the at least one processor is further configured to:
activate SCell based on the PHR report.

15. The apparatus of claim 13, wherein the at least one processor is further configured to:
balance uplink scheduling between the PCell and SCell based on historical transmission success rates.

16. The apparatus of claim 13, wherein the at least one processor is further configured to:
modify grant distributions based on the PHR report on SCell deviating from an actual transmission performance.

17. The apparatus of claim 16, wherein the deviations correspond to at least one of:
path loss difference between the PCell and SCell as reported by the apparatus,
measured Block Error Rate (BLER) on each uplink transmission, or
network congestion levels and interference from neighboring cells.

18. The apparatus of claim 16, wherein the at least one processor is further configured to:
adjusting apparatus scheduling by applying a low pass filter in the PHR values over time or based on a prediction of future uplink power availability based on past transmission patterns by the user equipment.

19. The apparatus of claim 13, wherein the at least one processor is further configured to:
coordinating PHR interpretation across multiple SCells by assigning dynamic weights to the PHR values from different cells based on a reported path loss by the apparatus, and prioritizing SCells with a lower BLER.

20. A method of wireless communication at a user equipment (UE), comprising:
calculating an initial power headroom report (PHR) for a secondary Cell (SCell) based on a combination of a PHR reported for a primary cell (PCell) as a baseline and an estimated SCell path loss relative to the PCell,
adjusting the PHR for the SCell based on subsequent actual uplink transmissions on the SCell,
dynamically adjusting PHR for a specific cell based on a total available UE power and network scheduling patterns, and
reporting the PHR on the SCell based on network scheduling.
